(19) United States
(12) Patent Application Publication
(10) Pub. No.: US 2003/0224776 A1
(43) Pub. Date: Dec. 4, 2003

(54) System and method for providing descriptions of tourist attractions from internet servers to wireless devices

(76) Inventor: Yu Meng, Bronx, NY (US)

Correspondence Address: Yu Meng, Apt 3D, 3512 Oxford Ave, Bronx, NY, 10463, US

(21) Appl. No.: 10/452,875

(22) Filed: Jun. 2, 2003

Related U.S. Application Data
(60) Provisional application No. 60/384,968, filed on Jun. 3, 2002.

(51) Int. Cl. H04Q 7/20

(52) U.S. Cl. 455/422.1; 455/457

(57) ABSTRACT

The system and method of the invention provide descriptions of tourist attractions to wireless devices. They provide an alternative way of obtaining dynamic descriptions for tourists who lack fast Internet connections. Updated attraction descriptions are stored on Internet servers and are classified and indexed by the geographical locations of the attractions. Desired information is customized for each wireless device and delivered to users through Internet and wireless networks.

### CROSS-REFERENCE TO RELATED APPLICATION

This application claims priority to U.S. Provisional Patent Application Serial No. 60/384,968, filed Jun. 3, 2002.

### FEDERALLY SPONSORED RESEARCH

Not Applicable

### SEQUENCE LISTING OR PROGRAM

Not Applicable

### BACKGROUND OF THE INVENTION

This invention relates to a system and method of providing descriptions of tourist attractions from Internet servers to wireless devices.

Obtaining accurate and adequate travel information is usually difficult for tourists. They need travel information that is researched and prepared by professionals in particular geographical areas. And the information must be up to date.

Tourists need guidance when they reach an unfamiliar tourism site. When they visit a tourist attraction, historical, descriptive, and other information is helpful. There are several traditional ways to get this information. Tourists can read wall labels or tour guidebooks, listen to tour guides, ask their friends, or surf the Internet.

There are serious problems with all those methods.

Wall labels have several limitations. First, many tourist attractions do not have wall labels. Second, the information on a wall label usually is very brief and is rarely updated. Third, when a tourist site is crowded, getting close to wall labels becomes difficult, and having enough time to read them carefully may be impossible. Fourth, tourists can't read wall labels unless they actually visit tourist attractions in person.

There are also problems with guidebooks. For example, information about a specific attraction may not be in the book. Also, much information in a guidebook becomes out of date as soon as the book is published.

Some tourists depend on a tour guide. But many people prefer not to do this, because they do not want to be tied to the guide's schedule. In addition, a tour guide may not be well informed or may not communicate well.

If tourists depend on their friends, they may get inaccurate or insufficient information.

Regarding the Internet, many web servers provide travel information. The information is stored on the servers and is easy to keep updated. It is practical to gather high-quality information from professionals. However, many descriptions of tourist attractions are not stored on the Internet. Moreover, descriptions of tourist attractions on the Internet are on web servers scattered around the world, so searching for specific information requires a fast Internet connection. A fast connection is not available to tourists most of the time. In addition, searching for such information is usually time consuming, and is not practical when tourists have time restraints.

Even as recently as a few years ago, only a few people had wireless devices, such as cellular phones, pagers, and wireless PDAs. Even fewer people had Internet access with their wireless devices. Nowadays, partly because the cost has decreased a lot, many people have Internet-enabled wireless devices and bring the devices with them when they travel. It is very easy for them to get wireless network information from their wireless devices.

The present invention provides a system and method of providing descriptions of tourist attractions from Internet servers to wireless devices. High-quality and up-to-date information prepared by experts is stored on the Internet. Because all descriptions are classified and indexed according to geographical locations, information requested by tourists is easy to be accessed. The global positioning system (GPS) and base-station-dependent technology can be used to ascertain the location of the user with the wireless device. Based on the user's location, the user has the option of requesting that the system search the tourist descriptions within the immediate area surrounding the user. Thus, the system could deliver relevant descriptions more quickly and efficiently.

None of the prior systems provide descriptions of tourist attractions from Internet servers to wireless devices.

### BRIEF SUMMARY OF THE INVENTION

It is an object of the invention to provide descriptions of tourist attractions with dynamic contents from Internet servers to wireless devices.

The attraction may be a tourism site or an object on public display.

Briefly, the present invention relates to a system and method for storing descriptions of tourist attractions in a database.

The descriptions are classified and indexed according to their geographical locations.

Globally unique strings that identify attractions based upon their geographical locations and/or categories (GUAIDs) may be used during the classification and indexing.

According to the user request, the system searches the database and gathers relevant information.

The information will be delivered to the wireless device through Internet and wireless networks.

In general, the present invention provides a system and method of providing descriptions of tourist attractions to wireless devices. Updated descriptions are stored on Internet servers and delivered to wireless devices as requested.

The above and other objects and advantages of the invention will become more readily apparent when reference is made to the description in conjunction with the accompanying drawings.

### BRIEF DESCRIPTION OF THE DRAWINGS

FIG. 1 is a diagram illustrating the location of the description system of the present invention in a typical system for wireless Internet.

FIG. 2 is an overall block diagram of the description system typical of the present invention shown in FIG. 1.

FIG. 3 is a block diagram of the Attraction Information Database shown in FIG. 2.

FIG. 4 is a flow chart illustrating the operations of the User Interface Module shown in FIG. 2.

### DETAILED DESCRIPTION OF THE INVENTION

Glossary of Terminology

Tourist Attraction

A tourism site or an object on public display

Attraction

An abbreviation for “Tourist Attraction”

Description System

The computer system constructed for the present invention that provides descriptions of tourist attractions

Data Transmission Lines

Lines used in a communications network (preferably the Internet) to connect an administrator and the description system

Globally Unique Attraction Identifier

A globally unique string that identifies an attraction based upon its geographical location and/or category

GUAID

An abbreviation for “Globally Unique Attraction Identifier”

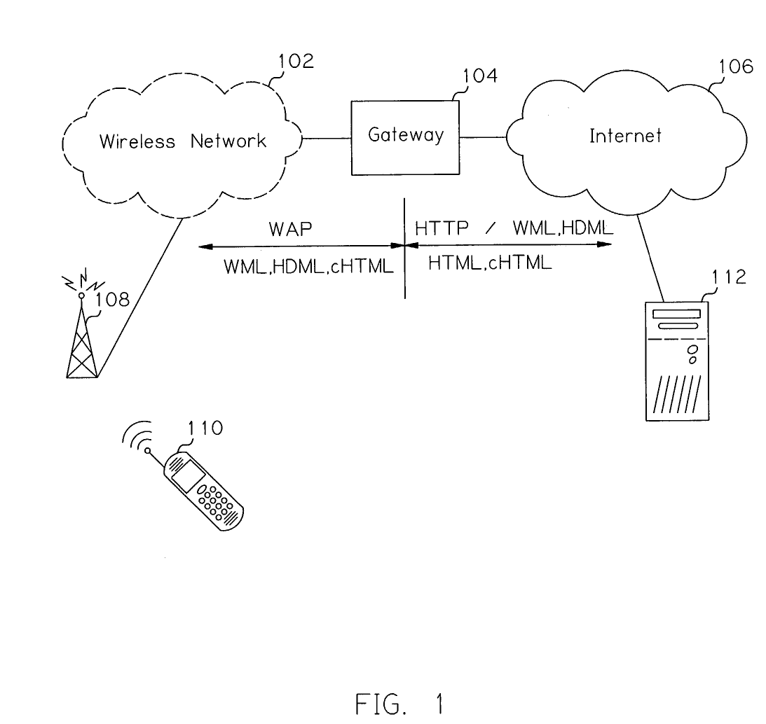

In the drawings, FIG. 1 is a diagram illustrating the position of the description system of the present invention in a typical system for wireless Internet.

As shown, a Wireless Network 102 is coupled to the Internet 106 via a Gateway 104. The Wireless Network 102 includes a significant infrastructure, only a portion of which is illustrated in FIG. 1. Base transceiver station 108 facilitates wireless communications with wireless device 110.

The Wireless Network 102 connects to the Internet 106 via the Gateway 104. The Gateway 104 serves to convert communications as they pass between the Wireless Network 102 and the Internet 106. Coupled to the Internet 106 is the description system 112 located on Internet servers, which provides attraction information via the Internet 106. Wireless device 110 supports communication with the Internet via compatible languages and protocols.

One particular protocol supported by the Wireless Network 102 may be the Wireless Application Protocol (WAP).

The wireless device 110 may support one or more markup languages, such as Wireless Markup Language (WML), Handheld Device Markup Language (HDML) and compact HyperText Markup Language (cHTML). Similar to regular HTML, cHTML, WML, or HDML language is a tag-based document language that comprises a set of commands or statements specified in a file that specifies how information is to be processed on the wireless device 110.

The Internet 106 supports the Hypertext Transport Protocol (HTTP), HDML, cHTML and WML for communications between the wireless device 110 and the description system 112. However, as is known, the Internet 106 also supports communications in the Hypertext Markup Language (HTML). HTML does not scale well to small displays and mouse-less user interfaces, and is a practical impossibility for delivering information to wireless devices with size, memory and cost constraints. The Gateway 104, among other operations in facilitating communication between the Internet 106 and the Wireless Network 102, converts communications between WAP and HTTP, the Gateway 104 supporting communications according to HTTP on its Internet 106 connection and according to WAP on its Wireless Network 102 connection.

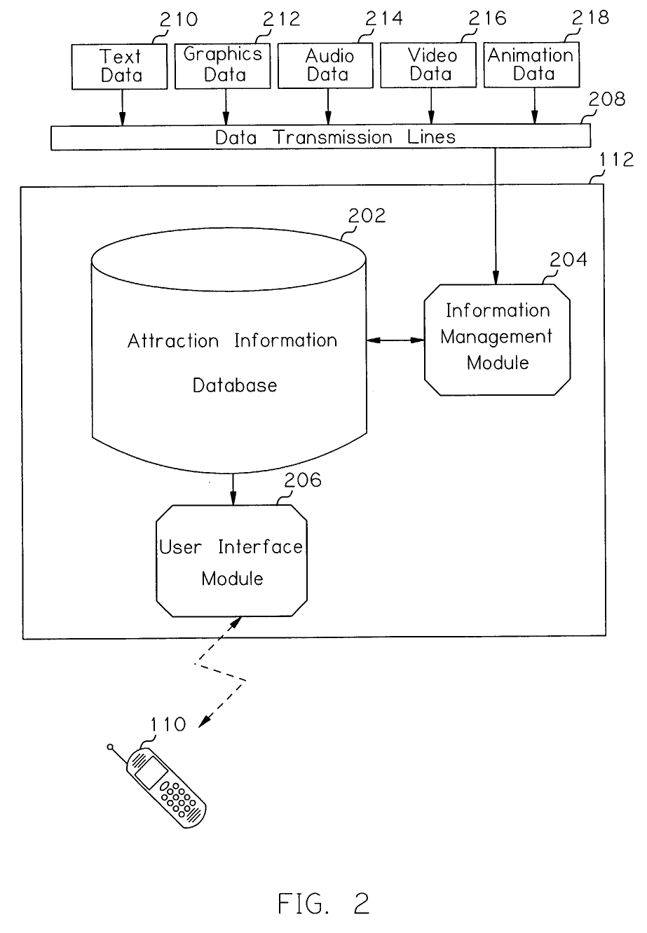

FIG. 2 is an overall block diagram of the description system typical of the present invention shown in FIG. 1.

In this system, the description system 112 shown in FIG. 1 contains Attraction Information Database 202, Information Management Module 204, and User Interface Module 206.

The description system 112 exchanges data with the system administrator through Data Transmission Lines 208.

The Information Management Module 204 controls the data input.

The input data contain Text Data 210, Graphics Data 212, Audio Data 214, Video Data 216, and/or Animation Data 218.

The User Interface Module 206 provides the user interface, performs the search based upon a user's requests, and delivers relevant information to the wireless device 110.

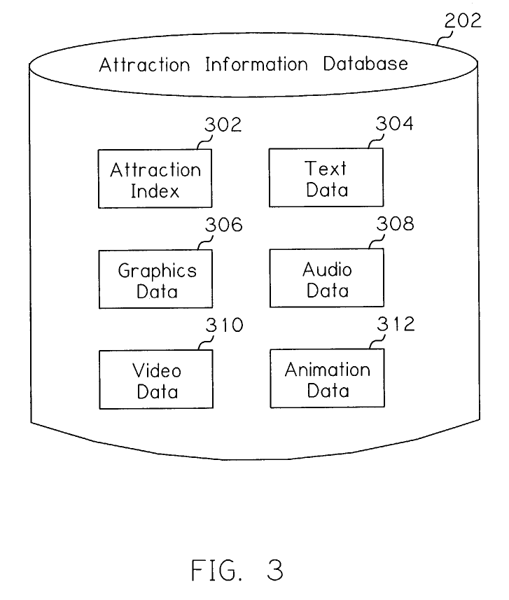

FIG. 3 is a block diagram of the Attraction Information Database shown in FIG. 2.

The Attraction Information Database 202 shown in FIG. 2 consists of Attraction Index 302, Text Data 304, Graphics Data 306, Audio Data 308, Video Data 310, and/or Animation Data 312.

The Attraction Index 302 contains information about name, location, and/or GUAID of the attraction.

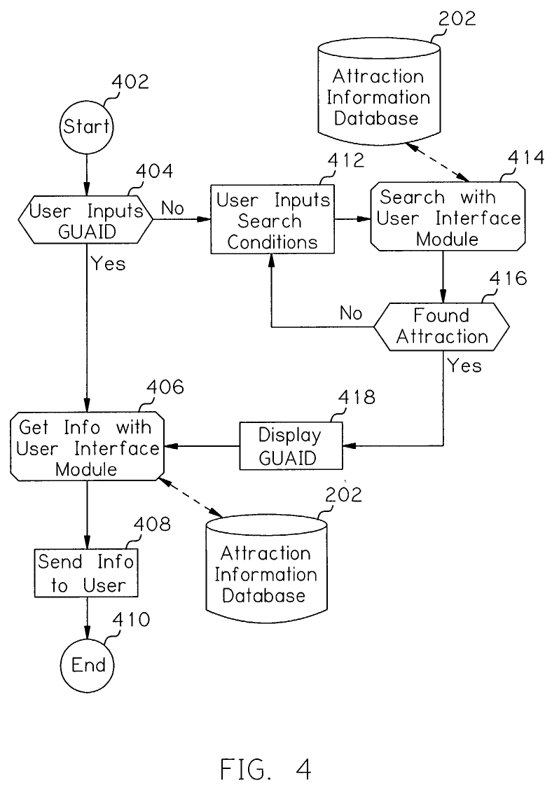

FIG. 4 is a flow chart illustrating the operations of the User Interface Module shown in FIG. 2.

Processing begins at Start block 402.

Decision block 404 determines whether the user inputted GUAID. If the user did, the program receives GUAID and proceeds to block 406.

Block 406 accesses the database 202 and generates an information package.

When the user did not specify GUAID at decision block 404, processing proceeds to block 412, where the program receives search conditions from the user.

Module 414 searches the database 202 according to the user's search conditions.

Decision block 416 determines whether module 414 found the specified attraction. If not, the processing returns to block 412 and asks the user to reenter the search conditions. If the attraction was found, the system displays GUAID at block 418. The system accesses the database 202 and generates an information package, as the user requested, at block 406.

Processing goes to block 408, where the information package is delivered to the user, and terminates at stop block 410.

Advantages

From the description above, a number of advantages of the present invention become evident:

(a) Descriptions of tourist attractions are accessible to tourists who lack fast Internet connections and are using wireless devices.

(b) Because descriptions of tourist attractions are stored on Internet servers, high-quality information can be gathered and prepared by professionals and kept updated.

(c) The descriptions are classified and indexed by their geographical locations, making them easy to access.

(d) The contents are customized for each wireless device. Therefore, the desired information can be delivered to wireless devices efficiently.

Conclusion and Scope

Accordingly, readers can see that the present invention can be used to provide descriptions of tourist attractions from Internet servers to wireless devices. Tourists on the go often lack fast Internet connections; the invention provides a way for them to get dynamic, up-to-date, high-quality descriptions of tourist attractions. The information is classified and indexed for easy access and customized for each wireless device.

Although the present invention has been described in detail, it will be understood that this description is not intended to limit the invention to this embodiment. Instead, it is intended to cover all alternatives, modifications and equivalents as may be included within the spirit and scope of the present invention as defined by the appended claims.

I claim:

1. For use with wireless Internet, a description system for providing descriptions of tourist attractions from Internet servers to wireless devices, comprising:
a database storing attraction information; and
means for searching the information and providing an information package based upon a user's requests.

2. The description system as recited in claim 1 wherein said tourist attractions refer to the group consisting of:
tourism sites,
objects on public display.

3. The description system as recited in claim 1 wherein said database storing attraction information contains data selected from the group consisting of:
attraction index,
text data,
graphics data,
audio data,
video data,
animation data.

4. The description system as recited in claim 1 wherein said means for searching the information and providing an information package comprising:
means for storing information in a database;
means for searching the database based upon a user's requests;
means for generating an information package which the user requested;
means for delivering the information package.

5. A computer-implemented description method for providing descriptions of tourist attractions from Internet servers to wireless devices, comprising the steps of:
storing attraction information in a database; and
searching the information and providing an information package based upon a user's requests.

6. The description method as recited in claim 5 wherein said tourist attractions refer to the group consisting of:
tourism sites,
objects on public display.

7. The description method as recited in claim 5 wherein said storing attraction information contains data selected from the group consisting of:
attraction index,
text data,
graphics data,
audio data,
video data,
animation data.

8. The description method as recited in claim 5 wherein said searching the information and providing an information package comprising the steps of:
storing information in a database;
searching the database based upon the user's requests;
generating an information package which the user requested;
delivering the information package.
